(19) United States
(12) Patent Application Publication
(10) Pub. No.: US 2012/0026340 A1
(43) Pub. Date: Feb. 2, 2012

(54) SYSTEMS AND METHODS FOR PRESENTING VIDEO DATA

(75) Inventor: Denis Mikhalkin, New South Whales (AU)

(73) Assignee: HONEYWELL INTERNATIONAL INC., Morristown, NJ (US)

(21) Appl. No.: 13/144,678

(22) PCT Filed: Jan. 13, 2010
(86) PCT No.: PCT/AU2010/000025

§ 371 Date: Oct. 17, 2011

(30) Foreign Application Priority Data
Jan. 15, 2009 (AU) 2009900169

(51) Int. Cl. H04N 5/225

(52) U.S. Cl. 348/169; 348/E05.024

(57) ABSTRACT

Described herein are systems and methods for presenting video data to a user. In overview, video data originates from a source, such as a capture device in the form of a camera. This video data is defined by a plurality of sequential frames, having a common geometric size. This size is referred to as the “geometric bounds of captured video data”. Analytics software is used to track objects in the captured video data, and provide position data indicative of the location of a tracked object relative to the geometric bounds of captured video data. Video data is presented to a user via a “view port”. By default, this view port is configured to display video data corresponding to geometric bounds of captured video data. That is, the view port displays the full scope of video data, as captured. Embodiments of the present invention use the position data to selectively adjust the view port to display a geometrically reduced portion of the geometric bounds of captured video data, thereby to assist the user in following a tracked object.

### FIELD OF THE INVENTION

The present invention relates to systems and methods for presenting video data to a user. Embodiments of the invention have been particularly developed for applying digital transformations to captured video data for the purpose of following objects that are identified and tracked in the captured video data. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In the field of video surveillance, it is known to use a software application to track objects that are identified in captured video data. In a straightforward example, a software application receives video data, and processes that data based on a predefined algorithm to identify the presence and location of an object. The application periodically outputs data indicative of the position of that object relative to the capture boundary of the camera.

Attempts have been made to control movable cameras so as to follow a tracked object. However, these suffer from various deficiencies, including the complexity, overheads, and complications associated with applying control commands to a remote camera based on the output of analytics software.

### SUMMARY OF THE INVENTION

It is an object of the present invention to overcome or ameliorate at least one of the disadvantages of the prior art, or to provide a useful alternative.

One embodiment provides a method for presenting video data to a user, the method including the steps of:
(a) receiving input indicative of captured video data; and
(b) displaying to the user a geometric portion of the captured video data, wherein the geometric portion is determined by reference to position data describing the location of a tracked object in the captured video data, and wherein, responsive to a variation in the location of the tracked object in the captured video data, the geometric portion is varied by reference to the varied location of the tracked object in the captured video data.

One embodiment provides a method for presenting video data to a user, the method including the steps of:
(a) displaying captured video data to a user via a view port;
(b) receiving input indicative of a request to follow an object;
(c) determining whether the request corresponds to a known tracked object;
(d) in the event that the request corresponds to a known tracked object, applying a digital zoom transformation such that the object occupies a greater proportion of the view port; and
(e) applying further transformations such that the view port follows the object.

One embodiment provides a computer system including a processor configured to perform a method as described herein.

One embodiment provides a computer program product configured to perform a method as described herein.

One embodiment provides a computer readable medium carrying a set of instructions that when executed by one or more processors cause the one or more processors to perform a method as described herein.

One embodiment provides a system for presenting video data to a user, the system including:

a capture device for providing captured video data;

an analytics module that is responsive to the captured video data for providing position data describing the location of a tracked object in the captured video data; and

a module for displaying to the user a geometric portion of the captured video data, wherein the geometric portion is determined by reference to the position data, and wherein, responsive to a variation in the location of the tracked object in the captured video data, the geometric portion is varied by reference to the varied location of the tracked object in the captured video data.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a schematic representation of a system according to one embodiment.

FIG. 2 is a schematic representation of a video presentation arrangement.

FIG. 3 shows a method according to one embodiment.

FIG. 4 shows exemplary view ports according to one embodiment.

FIG. 5 shows a method according to one embodiment.

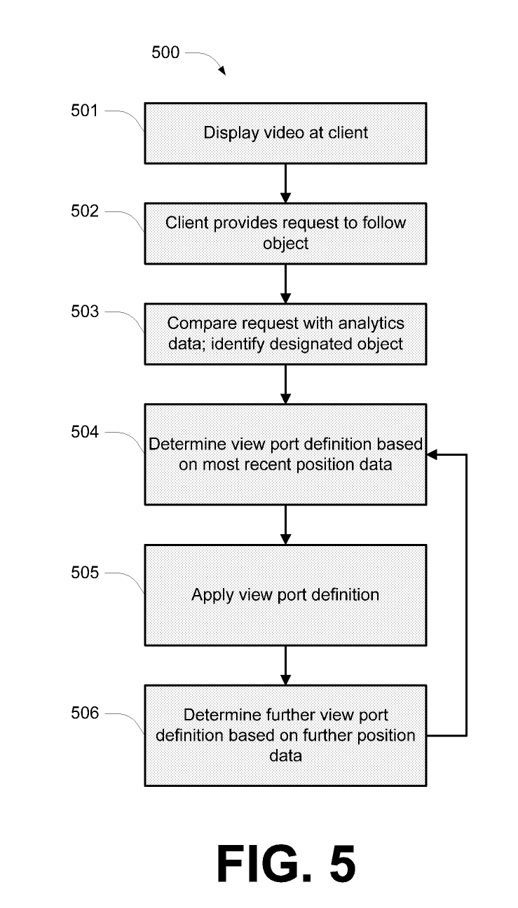

### DETAILED DESCRIPTION

Described herein are systems and methods for presenting video data to a user. In overview, video data originates from a source, such as a capture device in the form of a camera. This video data is defined by a plurality of sequential frames, having a common geometric size. This size is referred to as the “geometric bounds of captured video data”. Analytics software is used to track objects in the captured video data, and provide position data indicative of the location of a tracked object relative to the geometric bounds of captured video data. Video data is presented to a user via a “view port”. By default, this view port is configured to display video data corresponding to geometric bounds of captured video data. That is, the view port displays the full scope of video data, as captured. Embodiments of the present invention use the position data to selectively adjust the view port to display a geometrically reduced portion of the geometric bounds of captured video data, thereby to assist the user in following a tracked object.

### System Level Overview

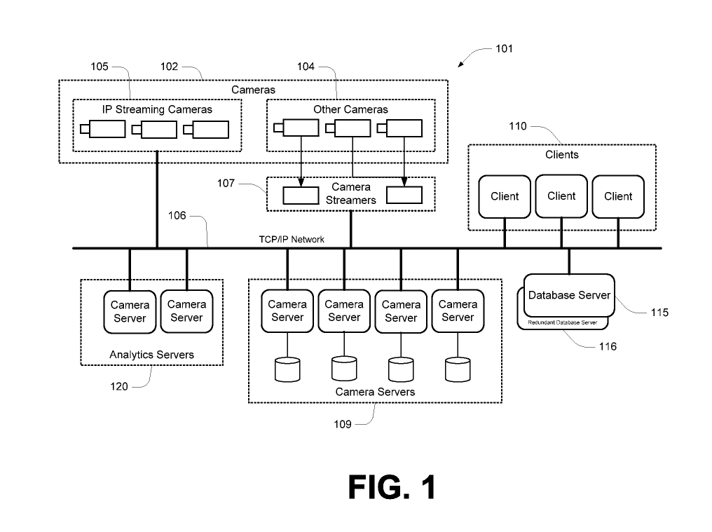

FIG. 1 illustrates a Digital Video Management (DVM) system 101. This is provided for the sake of illustration only, and it will be appreciated that embodiments of the present invention are by no means limited to application in an arrangement based on system 101, and are applicable in substantially any situation wherein video is displayed at a client terminal.

System 101 includes a plurality of cameras 102. Cameras 102 include conventional cameras 104 (including analogue video cameras), and IP streaming cameras 105. Cameras 102 stream video data, presently in the form of surveillance footage, on a TCP/IP network 106. This is readily achieved using IP streaming cameras 105, which are inherently adapted for such a task. However, in the case of other cameras 104 (such as conventional analogue cameras), a camera streamer 107 is required to convert a captured video signal into a format suitable for IP streaming. A plurality of digital cameras 104 can be connected to a single streamer 107, however it is preferable to have the streamer in close proximity to the camera, and as such multiple streamers are often used. In some embodiments the IP streamers are provided by one or more camera servers.

Two or more camera servers 109 are also connected to network 106 (these may be either physical servers or virtual servers). Each camera server is enabled to have assigned to it one or more of cameras 102. This assignment is carried out using a software-based configuration tool, and it follows that camera assignment is virtual rather then physical. That is, the relationships are set by software configuration rather than hardware manipulation. In practice, each camera has a unique identifier. Data indicative of this identifier is included with surveillance footage being streamed by that camera such that components on the network are able to ascertain from which camera a given stream originates.

In the present embodiment, camera servers are responsible for making available both live and stored video data. In relation to the former, each camera server provides a live stream interface, which consists of socket connections between the camera manager and clients. Clients request live video through the camera server's COM interfaces and the camera server then pipes video and audio straight from the camera encoder to the client through TCP sockets. In relation to the latter, each camera server has access to a data store for recording video data. Although FIG. 1 suggests a one-to-one relationship between camera servers and data stores, this is by no means necessary. Each camera server also provides a playback stream interface, which consists of socket connections between the camera manager and clients. Clients create and control the playback of video stored that the camera server's data store through the camera manager's COM interfaces and the stream is sent to clients via TCP sockets.

Although, in the context of the present disclosure, there is discussion of one or more cameras being assigned to a common camera server, this is a conceptual notion, and is essentially no different from a camera server being assigned to one or more cameras.

Clients 110 execute on a plurality of client terminals, which in some embodiments include all computational platform on network 106 that are provided with appropriate permissions. Clients 110 provide a user interface that allows surveillance footage to be viewed in real time by an end-user. In some cases this user interface is provided through an existing application (such as Microsoft Internet Explorer), whilst in other cases it is a standalone application. The user interface optionally provides the end-user with access to other system and camera functionalities, including the likes of including mechanical and optical camera controls, control over video storage, and other configuration and administrative functionalities (such as the assignment and reassignment of cameras to camera servers). Typically clients 110 are relatively “thin”, and commands provided via the relevant user interfaces are implemented at a remote server, typically a camera server. In some embodiments different clients have different levels of access rights. For example, in some embodiments there is a desire to limit the number of users with access to change configuration settings or mechanically control cameras.

System 101 also includes a database server 115. Database server 115 is responsible for maintaining various information relating to configurations and operational characteristics of system 101. In the present example, the system makes use of a preferred and redundant database server (115 and 116 respectively), the redundant server essentially operating as a backup for the preferred server. The relationship between these database servers is generally beyond the concern of the present disclosure.

System 101 additionally includes analytic servers 120, which perform analytical processing on captured video (either by way of communication with cameras or camera servers, depending on the specific implementation). In some embodiments this functionality is integrated with one or more camera servers. In overview, captured video is analyzed, for example on the basis of a software application configured to track identified targets, and information regarding the analysis provided to clients.

### Concept Overview

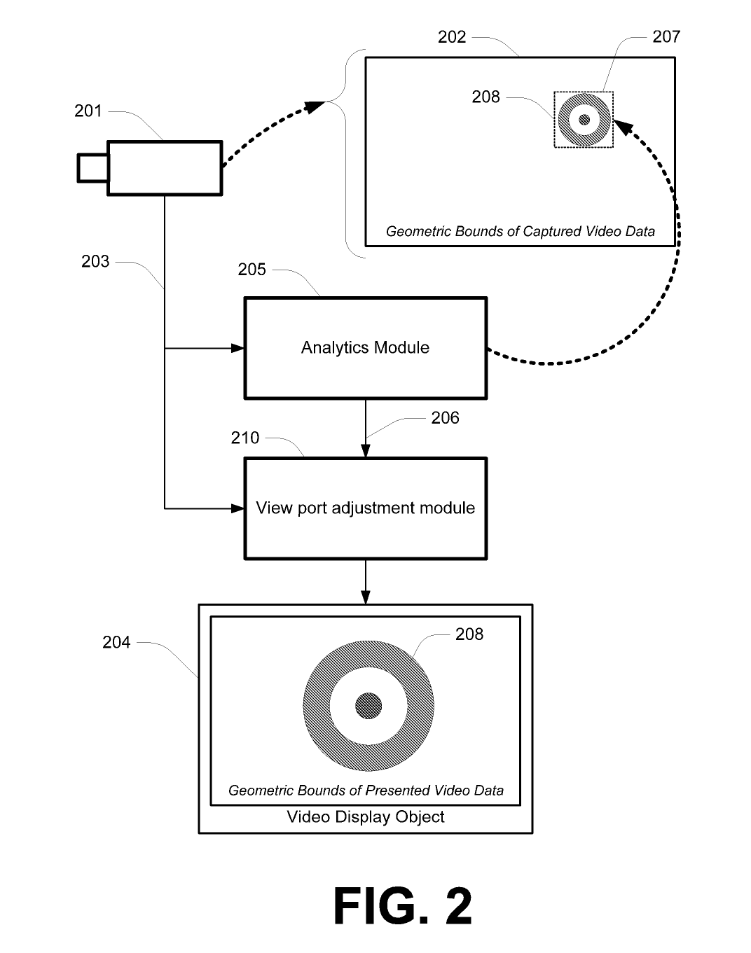

FIG. 2 provides a conceptual overview of an embodiment of the present invention. This arrangement is in some embodiments implemented by way of a DVM system such as system 101. However, various simplifications are made for the sake of explanation.

A camera 201 is configured to capture video data, in the form of a plurality of sequential frames. This video data has geometric bounds, defined by the configuration of the camera (for example in terms of optical components and a CCD that are present). In board terms, the term “geometric bounds of captured video data” is used to describe the boundary (typically rectangular) of video frames displayable based on the captured video. These bounds generally remain constant regardless of how the video is presented to a user (for example based on different display screen/display window sizes, or resolutions), although there is in some cases minor clipping due to aspect ratio correction, or the like. For the present purposes, the geometric bounds of captured video data is described by a rectangle having a width Xₘₐₓ and a height Yₘₐₓ, such that coordinates (X,Y) within the geometric bounds satisfy the equations 0≦X≦Xₘₐₓ and 0≦Y≦Yₘₐₓ. In FIG. 2, the geometric bounds are indicated by rectangle 202, which contains an exemplary video frame.

Camera 201 provides video data 203 for display at a video display object 204, which is in the present embodiment a software-based object running at a client terminal, thereby to present video data to the client. For example, the video display object may be provided via an HTML page in a web browser, or the like, and presents video data obtained from a camera server. Video display object 204 presents video data in accordance with a view port definition, which defines the bounds of presented video data relative to the bounds of captured video data. By way of example, in a conventional scenario, the view port definition defines bounds of presented video data as being the same as the bounds of captured video data—the view port simply shows the full geometric scope of video data as captured. However, in the present embodiments, alternate view port definitions are also able to be defined, such that the view port shows only a portion (defined geometrically rather than temporally) of the captured video data. For example, this may be achieved by way of a digital zoom transformation.

By way of example, assume that the geometric bounds of captured video data is described by a rectangle having a width Xₘₐₓ and a height Yₘₐₓ, such that coordinates (X,Y) within the geometric bounds satisfy the equations 0≦X≦Xₘₐₓ and 0≦X≦Yₘₐₓ. A view port definition would define a rectangle such that coordinates (X,Y) satisfy the equations A≦X≦(Xₘₐₓ−B) and C≦Y≦Yₘₐₓ−D), where A, B, C and D are positive numbers, with the limitation that (A+B)<Xₘₐₓ and (C+D)<Yₘₐₓ (meaning the view port falls within the geometric bounds of captured video data). In some embodiments the view port has the same aspect ratio as the geometric bounds of captured video data.

In the present embodiments, video data is presented via object 204 in real time. That is, video data is presented substantially as it is captured, subject to processing delays, network delays and/or buffering.

Video data 203 is provided to an analytics module 205, which is presently considered to be a software component executing on an analytics server. Analytics module 205 is responsive to video data 203 for tracking one or more objects, based on a predefined tracking algorithm. Analytics module 205 outputs position data 206, which describes the location of a tracked object at a time Tₙ (or for a frame corresponding to a time Tₙ) relative to the geometric bounds of captured video. For the sake of the present example, analytics module 205 provides position data 206 which describes the coordinates of a rectangle 207 around a tracked object 208 (shown in the exemplary frame contained within rectangle 202). In other embodiments alternate position data is provided, for example being based on a single point or a number of points within or around a tracked object.

Based on position data 206, it is possible to determine the location of an object relative to the geometric bounds of captured video data at time Tₙ.

The precise tracking algorithm used varies between embodiments. Some embodiments make use of Active Alert®, which is a product provided by Honeywell. This product has the ability to continuously track and report object locations, and position data is provided via XML packets, which are sent over HTTP connections to authenticated clients (such as camera servers).

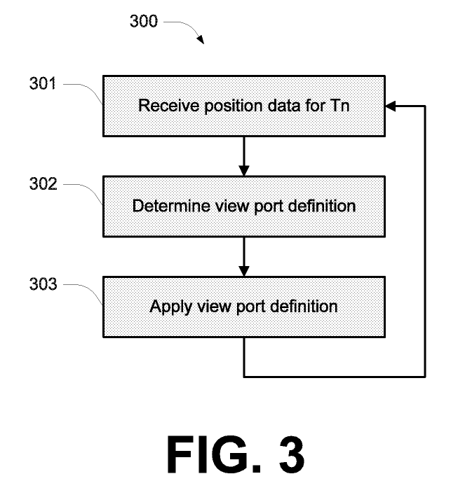

A view port adjustment module 210 is responsive to data 206 for determining a view port definition for display object 204. An exemplary method for determining a view port definition is provided by method 300 of FIG. 3. Step 301 includes receiving position data for a time Tₙ. Based on position data for time Tₙ, a view port definition is determined based on predefined constraints at step 302. At step 303, this view port definition is applied via object 204. For example, in some embodiments this includes applying a transformation to video data presented via object 204, or applying a transformation to video data that is being streamed to object 204 (for example where the object is viewed at a thin client terminal). Method 300 then loops to step 301 as additional position data is received. In other embodiments more sophisticated approaches are adopted, for example making use of smoothing protocols as described below.

The predefined constraints vary between embodiments. However, at a broad level, these operate such that the tracked object occupies a greater proportion of the view port than it does the bounds of captured video data (for example, if the view port and bounds of captured video were presented side-by-side in identically sized player windows, the object would appear comparatively larger in the view port, and comparatively smaller in the bounds of captured vide data). That is, a digital zoom transformation is applied. In one embodiment the constraints require that the tracked object (defined in terms of rectangle 207) occupy a predefined proportion of the bounds of presented video data. In some cases, this predefined proportion is about 80%. However, other proportions in the order of between 60% and 90% are also considered. The proportion may be defined in terms of area, or in terms of horizontal and/or vertical dimensions. For example, in cases where rectangle 207 has an aspect ratio different from the bounds of captured video (or the bounds of video displayable via object 208), the larger of the vertical or horizontal dimension is considered when applying the constraint (for example, in one example where rectangle 207 is of greater height than width, a transformation is applied such that rectangle 207 occupies 80% of the bounds of presented video data in terms of height).

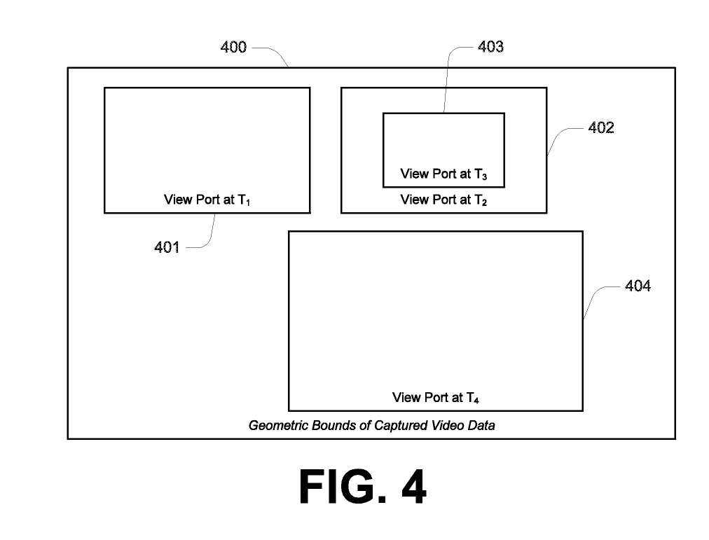

It will be appreciated that the view port definition is relative to the bounds of captured video. This is schematically illustrated in FIG. 4. Rectangle 400 indicates the geometric bounds of captured video data at time Tₙ. Rectangles 401, 402, 403 and 404 respectively represent view port definitions at times T₁, T₂, T₃ and T₄. These are intended to represent the manner in which a view port can be moved. At T₀, we assume that the view port corresponds to rectangle 400 (i.e. the full scope of captured video is presented). At T₁, a transformation has been applied to the view port such that it corresponds with rectangle 401, requiring a transformation of position and size. Between T₁ and T₂, the view port is moved vertically and horizontally, for example to follow vertical and horizontal movement of a tracked object. This requires only a transformation of position. Between T₂ and T₃, the view port moves by way of size adjustment, requiring a transformation of size. It will be appreciated that such a transformation is effectively a digital zoom transformation. In practice, this would occur where a tracked object moves away from a camera, and appears in two dimensions to be decreasing in size. Between T₃ and T₄, the view port moves by way of size adjustment and position adjustment. This would occur where a tracked object moves towards diagonally towards the camera.

The regularity with which the view port definition is adjusted varies between embodiments, and is often affected by the regularity with which data 206 is provided. For example, various tracking algorithms are configured to provide data 206 either:
On a frame-by frame basis, or frame-based periodic rate (e.g. every 10 frames).
On a time-based periodic basis (e.g. every second, or every 5 seconds).
On a “need to know” basis (e.g. whenever the position of a tracked object varies by greater than a threshold value).

Irrespective of which of these occurs, there is a general principle whereby view port definitions are modified over time. That is, there is a present view port definition at time Tᵢ, and a destination view port definition for time Tᵢ₊ₐ, determined based on position data defined for position data corresponding to times Tᵢ, and Tᵢ₊ₐ (for example using frame identifiers as a point of time reference). In some embodiments, a smoothing protocol is implemented to relocate the view port between the present view port definition and the destination view port definition. This is optionally configured to reduce “jumping” in view port definition, such that the view port appears to pan or zoom smoothly with respect to the bounds of captured video. For example, by reference to FIG. 4, between T₁ and T₂ there would be a plurality of intermediate view port definitions such that, as viewed by a user, the view port appears to pan from side-to-side. To some extent, this mimics the “feel” of a moving camera, although the camera remains stationary at all times, and adjustment occurs at a software level.

In one embodiment, the smoothing protocol includes determining the variation between the current view port decision and the destination view port definition (determined in terms of distance and/or zoom), and incrementing this variation based on a predefined divisor (which is in some cases a predefined value, or in other cases defined by reference to the number of video frames between Tᵢ, and Tᵢ₊ₐ). For example, one embodiment includes determining the variation between current view port definition and destination view port definition (when the object would be fully inside of the view port), dividing this by a predetermined number, which is assumed to be six (6) for the present example, to determine an increment value, and applying a transformation based on that increment value on a frame-by-frame basis. That is, if the object jumped by 30 pixels between Tᵢ, and Tᵢ₊ₐ, transformations would increment movement of the view port by 5 pixels per frame for the 6 following frames (i.e. 30/6 pixels per frame). If an object jumped by 48 pixels between Tᵢ, and Tᵢ₊ₐ, transformations would increment movement of the view port by 8 pixels per frame for the 6 following frames (i.e. 48/6 pixels per frame).

In some embodiments, increment value determinations are revised on an ongoing basis. For instance, object position data may be received on a frame-by-frame basis, and increment determinations revised periodically (also optionally on a frame-by-frame basis) to account for an accelerating or decelerating object. Revisiting an example from above, if an object jumped by 30 pixels between Tᵢ, and Tᵢ₊ₐ, transformations increment movement of the view port by 5 pixels per frame for the 6 following frames. Over the course of the next two frames, the view port is moved by 10 pixels. New data may indicate, however, that the object had moved an additional 20 pixels compared with the initial measurement of 30 pixels. The remaining difference in distance between the view port center and the object is now (30 pixels−10 pixels)+20 pixels=40 pixels. That is, the difference was initially determined to be 30 pixels, there has been a movement of 10 pixels to “catch up”, but the object has moved by a further 20 pixels, and therefore the view port falls further behind. To account for this, the increment is updated to 40 pixels per frame for the following 6 frames (i.e. 40/6 pixels per frame). Again, this may be adjusted over the course of those six frames based on new data.

The above examples generally assume increment values are determined only in terms of magnitude. However, direction is also of importance. In one embodiment, increment values are defined in terms of an x-axis component and a y-axis component (for example an increment value might be described as “5x-axis pixels and 2 y-axis pixels per frame for the 6 following frames”. Furthermore, variations in increment are not only in magnitude, but also in direction.

To recap, the general approach is to continuously receive data indicative of object location, compare that data with a current view port definition and view port increment value (both magnitude and direction). On that basis an adjustment is selectively made to the view port increment value to account for variations in object movement characteristics.

In some embodiments the smoothing protocol estimates the velocity of a tracked object, and applies transformations to the view port based on that estimation. For example, if it is determined that, based on comparison between Tᵢ, and Tᵢ₊ₐ, the object is moving at 5 pixels per frame along a particular vector, the view port is moved along that vector at a corresponding rate. The rate of movement is then updated based on subsequent velocity estimates. This allows for view port variation to be predictive rather than reactionary; rather than determining the position of an object and adjusting the view port to accommodate that position, velocity estimates predict where the object will be at a later time, and subsequently adjust rate of movement where that prediction is inaccurate. For example, if object jumped by 30 pixels along a given vector between Tᵢ, and Tᵢ₊ₐ, then velocity would be estimated at 30 pixels per “a” units of time along that vector, and the view port would be moved at that rate along that vector until an updated estimate is determined.

In the example of FIG. 2, camera 210 provides video data 203 to modules 204 and 210. It is generally inferred, in this regard, that module 210 is responsible for providing video data to object 204. However, in other embodiments camera 201 provides video data 203 directly to object 204, and module 210 simply provides view port adjustment instructions.

In some embodiments border shading is provided in the view port, thereby to further assist user identification of an object. For example, a border extending between 5% and 20% inwards of the periphery of the view port is provided with a semi-transparent grey mask, or has color removed. In some embodiments this border is transformed independent of the smoothing protocol such that it remains centered around the tracked object.

The general concepts above, and various applications thereof, are described in more detail further below by reference to a specific method embodiment.

### Method Overview

FIG. 4 illustrates an exemplary method 500 according to one embodiment. This method is optionally performed at a camera server or at a client terminal, depending on where view port determinations are carried out from a processing perspective.

Step 501 includes displaying video at a client terminal, via a video display object. For the present purposes, it is assumed that a default view port is initially adopted, this default view port corresponding to the geometric bounds of captured video data for a capture device from which the video data originates.

At step 502, a client provides a request to follow an object. For example, this step may be defined by the receipt of data indicative of such a request at a view port adjustment module, such as module 210. In some embodiments such a request originates when a user interacts (for example by way of a mouse click) at a location within a video display object. That is, a user clicks on an object he/she wishes to follow, and data indicative of the time at which the click was made and the location of the click (relative to the geometric bounds of the view port or captured video data) is provided to a view port adjustment module.

Step 503 includes comparing the client request with analytics data, thereby to identify a tracked object designated by that user. For example, the location of the user's mouse click is analyzed to determine whether an analytics module was tracking an object at that location at the relevant time. To this end, it is not uncommon for an analytics module to be tracking multiple objects at any given time. If no such object can be identified, no action is taken, and the user optionally informed. However, assuming the user's mouse click corresponds (or substantially corresponds) with the location of a tracked object, that object is identified as the “designated object”, and position data for that object is used for subsequent view port variations.

Step 504 includes determining a view port definition based on the most recent position data, and this view port definition is applied at step 505. As such, the video data displayed at the video display object effectively zooms in on the location of the designated object. In some cases this is subjected to a smoothing protocol in a similar manner to that described above thereby to provide a more granulated shift between view port definitions (for example a gradual zoom towards the appropriate final view port). Further position data is received and a further view port definition defined at step 506, and the method loops to step 505 where that view port definition is applied (again optionally subject to a smoothing algorithm).

### CONCLUSIONS

It will be appreciated that the disclosure above provides various significant systems and methods for presenting video data. In particular, the present approaches allow a user to follow a tracked object on-screen substantially in real time without the need to adjust camera positions.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for presenting video data to a user, the method including the steps of:
(a) receiving input indicative of captured video data; and
(b) displaying to the user a geometric portion of the captured video data, wherein the geometric portion is determined by reference to position data describing the location of a tracked object in the captured video data, and wherein, responsive to a variation in the location of the tracked object in the captured video data, the geometric portion is varied by reference to the varied location of the tracked object in the captured video data.

2. A method according to claim 1 wherein displaying to the user a geometric portion of the captured video data includes applying a digital zoom transformation to the captured video data.

3. A method according to claim 1 wherein the geometric portion is controlled by a view port definition, and wherein the view port definition is determined based on the position data.

4. A method according to claim 3 wherein the view port definition is periodically adjusted based on updated position data, such that the video displayed to the user follows the tracked object.

5. A method to claim 3 wherein periodically adjusting the view port definition includes applying a smoothing protocol.

6. A method according to claim 5 wherein the smoothing protocol operates to adjust the view port definition from a current position to a destination position via a plurality of incremental steps.

7. A method according to claim 5 wherein the smoothing protocol estimates the velocity of the object relative to the captured video data thereby to predict a future view port definition.

8. A method according to claim 1 wherein the captured video is defined by geometric bounds of captured video, and the geometric portion displayed to the user is defined by geometric bounds of presented video data, and wherein the object occupies a greater proportion of the geometric bounds of presented video data as compared with the geometric bounds of captured video data.

9. A method according to claim 1 wherein position data is supplied by a tracking algorithm that processes the captured video data thereby to determine the location of one or more objects.

10. A method according to claim 1 wherein the geometric portion of the captured video data is displayed substantially in real time.

11. A method according to claim 1 wherein the tracked object is designated by a user.

12. A method according to claim 11 wherein the user designates the tracked object by way of interaction with video data displayed to the user.

13. A method for presenting video data to a user, the method including the steps of:
(a) displaying captured video data to a user via a view port;
(b) receiving input indicative of a request to follow an object;
(c) determining whether the request corresponds to a known tracked object;
(d) in the event that the request corresponds to a known tracked object, applying a digital zoom transformation such that the object occupies a greater proportion of the view port; and
(e) applying further transformations such that the view port follows the object.

14. A method according to claim 13 wherein an analytics module provides input indicative of one or more a known tracked objects.

15. A method according to claim 13 wherein the transformations are applied subject to a smoothing protocol.

16. A method according to claim 13 wherein the user provides the request to follow an object by way of a selection in the view port at the location of the object the user wishes to follow.

17. A method according to claim 16 wherein determining whether the request corresponds to a known tracked object includes comparing the location of the selection with position data for one or more known tracked objects at a corresponding time.

18. A computer system including a processor configured to perform a method according to any preceding claim.

19. A computer program product configured to perform a method according to any preceding claim.

20. A computer readable storage medium carrying a set of instructions that when executed by one or more processors cause the one or more processors to perform a method according to any preceding claim.

21. A system for presenting video data to a user, the system including:
a capture device for providing captured video data;
an analytics module that is responsive to the captured video data for providing position data describing the location of a tracked object in the captured video data; and
a module for displaying to the user a geometric portion of the captured video data, wherein the geometric portion is determined by reference to the position data, and wherein, responsive to a variation in the location of the tracked object in the captured video data, the geometric portion is varied by reference to the varied location of the tracked object in the captured video data.
